(19) United States
(12) Patent Application Publication
(10) Pub. No.: US 2018/0351865 A1
(43) Pub. Date: Dec. 6, 2018

(54) A lookup system and a lookup method

(71) Applicant: CORIANT OY, Espoo (FI)

(72) Inventors: Ville HALLIVUORI, Espoo (FI); Juhamatti KUUSISAARI, Helsinki (FI); Mika SILVOLA, Kempele (FI); Teemu KOSKI, Espoo (FI); Timo NARUMO, Espoo (FI)

(21) Appl. No.: 15/527,799

(22) PCT Filed: Nov. 12, 2015
(86) PCT No.: PCT/FI2015/050788

§ 371 Date: May 18, 2017

(30) Foreign Application Priority Data
Nov. 19, 2014 (FI) 20146012

(51) Int. Cl. H04L 12/743; H04L 12/723; H04L 12/933; H04L 12/741

(52) U.S. Cl. CPC H04L 45/7457; H04L 45/54; H04L 49/105; H04L 45/50

(57) ABSTRACT

A lookup system includes a ternary content-addressable memory TCAM configured to carry out a lookup on the basis of a lookup key so as to produce a preliminary lookup result. The lookup system further includes a subsystem configured to produce a final lookup result on the basis of the preliminary lookup result and auxiliary data including at least a part of bit values of do-not-care bit positions of the lookup key such that the preliminary lookup result is independent of the bit values of the do-not-care bit positions. The required number of TCAM-lines can be reduced because different alternatives of the auxiliary data corresponding to different possible bit values of the do-not-care bit positions of the lookup key are handled with the subsystem instead of the TCAM.

### TECHNICAL FIELD

The disclosure relates to a lookup system suitable for lookups such as, for example but not necessarily, Internet Protocol “IP”-address lookups. Furthermore, the disclosure relates to a lookup method and to a computer program for carrying out lookups. Furthermore, the disclosure relates to a network element such as, for example but not necessarily, an Internet Protocol “IP” router.

### BACKGROUND

A network element of a data transfer network comprises typically a lookup system for carrying out lookups so that a lookup key relates to data being managed by the network element and a lookup result produced by the lookup system determines at least partly operations to be carried out by the network element. The data being managed by the network element may comprise for example Internet Protocol “IP” packets, Ethernet frames, or some other data frames. The above-mentioned operations may comprise for example forwarding the data to appropriate one or more data transfer links of the data transfer network, discarding the data, and/or delivering the data to a central processing unit “CPU” of the network element for further processing. The above-mentioned lookup key may comprise for example a destination address, a source address, and/or other information related to the data being managed. The network element can be for example an Internet Protocol “IP” router, a multiprotocol label switching “MPLS” node, a packet optical switch, an Ethernet switch, an asynchronous transfer mode “ATM” switch, a software-defined networking “SDN” controlled network element, and/or a virtualized network function runnable in a virtual machine.

In many cases, a lookup system of the kind mentioned above is implemented with a ternary content-addressable memory “TCAM”. An inherent drawback of the TCAM is however that the TCAM is essentially more expensive than for example a random-access memory “RAM” having a same size as the TCAM. Furthermore, the power consumption of the TCAM is notably higher than the power consumption of the RAM when the TCAM and the RAM are used with a same reading frequency. For these reasons, in practical applications it is endeavored that the amount of the TCAM could be as small as possible.

A typical lookup system where Internet Protocol “IP” address lookups are implemented with a TCAM may consume even four TCAM-lines per each IP-address: an own address, a network address, a broad-cast address, and a connected network address. For example, a connected network 1.2.3.4/24 would have the following four TCAM lines: own address 1.2.3.4/32, network address 1.2.3.0/32, broad-cast address 1.2.3.255/32, and connected network address 1.2.3.0/24. For example in a case of 100,000 interfaces, there would be 400,000 TCAM-lines. In conjunction with the Internet Protocol version 6 “IPv6”, the situation is even more TCAM consuming because it is typical in the IPv6 that a single interface may have many IP-addresses.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new lookup system suitable for lookups such as, for example but not necessarily, Internet Protocol “IP”-address lookups. A lookup system according to the invention comprises:
a ternary content-addressable memory “TCAM” configured to carry out a lookup on the basis of a lookup key so as to produce a preliminary lookup result, the lookup key comprising do-not-care bit positions so that the preliminary lookup result is independent of bit values of the do-not-care bit positions, and
a subsystem configured to produce a lookup result on the basis of the preliminary lookup result and auxiliary data comprising at least a part of the bit values of the do-not-care bit positions of the lookup key.

The required number of TCAM-lines can be reduced because different alternatives of the auxiliary data corresponding to different possible bit values of the do-not-care bit positions of the lookup key are handled with the subsystem instead of the TCAM.

For example, in a case where there are the following addresses: own address 1.2.3.4/32, network address 1.2.3.0/32, broad-cast address 1.2.3.255/32, and connected network address 1.2.3.0/24, it is sufficient to have only one TCAM-line for the address 1.2.3.0/24. In a case where a lookup key under consideration matches the above-mentioned TCAM-line for 1.2.3.0/24, the leftmost byte of the lookup key corresponding to the do-not-care bit positions indicated by the 24 bits mask-length is checked by the above-mentioned subsystem in order to find out whether the leftmost byte is 4 when there is 1.2.3.4/32 match, or 0 when there is 1.2.3.0/32 match, or 255 when there is 1.2.3.255/32 match, or something else in which case the final lookup result is the 1.2.3.0/24 match.

In accordance with the invention, there is provided also a new network element for a data transfer network. The network element can be, for example, an Internet Protocol “IP” router, a multiprotocol label switching “MPLS” switch, a packet optical switch, an Ethernet switch, an asynchronous transfer mode “ATM” switch, a software-defined networking “SDN” controlled network element, and/or a virtualized network function runnable in a virtual machine. A network element according to the invention comprises:
a data transfer interface for connecting the network element to a data transfer network, and
a lookup system according to the invention for carrying out a lookup so that a lookup key of the lookup relates to data being managed by the network element and a lookup result produced by the lookup system at least partly determines operations to be carried out by the network element.

In accordance with the invention, there is provided also a new lookup method. A lookup method according to the invention comprises:
supplying a lookup key to a ternary content-addressable memory so as to obtain a preliminary lookup result, the lookup key comprising do-not-care bit positions so that the preliminary lookup result is independent of bit values of the do-not-care bit positions, and
producing a lookup result on the basis of the preliminary lookup result and auxiliary data comprising at least a part of the bit values of the do-not-care bit positions of the lookup key.

In accordance with the invention, there is provided also a new computer program for carrying out lookups. A computer program according to the invention comprises computer executable instructions for controlling a programmable processing system to:
supply a lookup key to a ternary content-addressable memory so as to obtain a preliminary lookup result, the lookup key comprising do-not-care bit positions so that the preliminary lookup result is independent of bit values of the do-not-care bit positions, and
produce a lookup result on the basis of the preliminary lookup result and auxiliary data comprising at least a part of the bit values of the do-not-care bit positions of the lookup key.

In accordance with the invention, there is provided also a new computer program product. The computer program product comprises a non-volatile computer readable medium, e.g. a compact disc “CD”, encoded with a computer program according to the invention.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in the accompanied dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

Exemplifying and non-limiting embodiments of the invention and their advantages are explained in greater detail below with reference to the accompanying drawings, in which:

FIGS. 1a and 1b show schematic illustrations of lookup systems according to exemplifying and non-limiting embodiments of the invention,

FIG. 2 shows a schematic illustration of a network element according to an exemplifying and non-limiting embodiment of the invention, and

FIG. 3 shows a flowchart of a lookup method according to an exemplifying and non-limiting embodiment of the invention.

### DESCRIPTION OF EXEMPLIFYING AND NON-LIMITING EMBODIMENTS

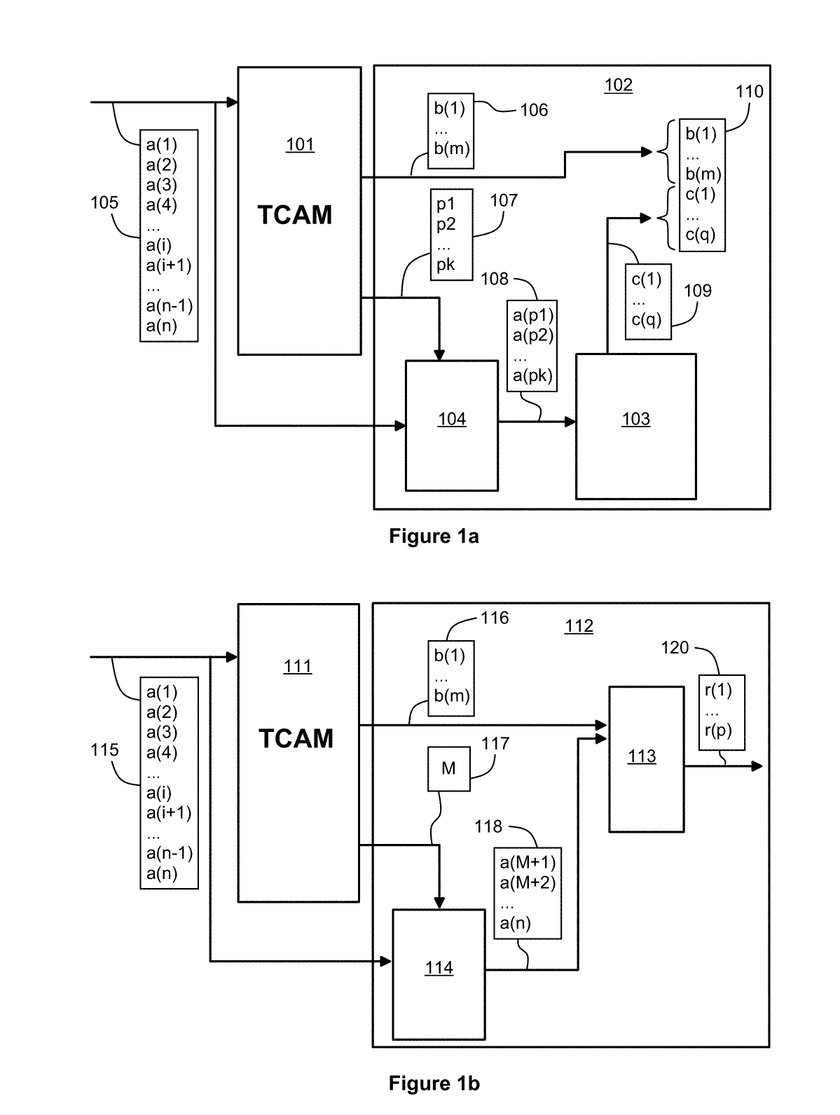

FIG. 1a shows a schematic illustration of a lookup system according to an exemplifying and non-limiting embodiment of the invention. The lookup system comprises a ternary content-addressable memory “TCAM” 101 configured to carry out a lookup on the basis of a lookup key 105 so as to produce a preliminary lookup result 106. The TCAM 101 can be a single TCAM device or a combination of many TCAM devices. In the exemplifying case illustrated in FIG. 1a, the lookup key is a vector of bit values a(1), a(2), . . . , a(n) where the indices 1, . . . , n indicate the bit positions of the lookup key and thus n is the word-length of the lookup key. Each of the bit values a(1) . . . a(n) can be either a first bit value such as e.g. zero ‘0’ or a second bit value such as e.g. one ‘1’. The preliminary lookup result 106 is a vector of bit values b(1), . . . b(m), where m is the word-length of the preliminary lookup result. In principle, it is also possible that the preliminary lookup result 106 comprises only one bit. The lookup system comprises a subsystem 102 configured to produce a final lookup result 110 on the basis of the preliminary lookup result 106 and auxiliary data 108 that comprises all or pre-determined ones, or one, of the bit values of do-not-care bit positions of the lookup key 105. The do-not-care bit positions are such bit positions of the lookup key 105 that the preliminary lookup result 106 produced by the TCAM is independent of the bit values of the do-not-care bit positions, i.e. the TCAM lookup does not care about these bit values. In this context, the do-not-care bit positions can be called also “preliminary do-not-care bit positions” because their bit values are not significant to the preliminary lookup result 106 produced by the TCAM 101 but all or predetermined ones of their bit values are/is significant to the final lookup result 110.

In the exemplifying lookup system illustrated in FIG. 1a, the TCAM 101 is configured to produce indicator data 107 in addition to the preliminary lookup result 106 when carrying out the lookup on the basis of the lookup key 105. The indicator data indicates the do-not-care bit positions of the lookup key 105. In this exemplifying case, the indicator data 107 comprises pointers p1, . . . , pk to the relevant do-not-care bit positions of the lookup key 105. Thus, the auxiliary data 108 comprises the bit values of the bit positions p1, . . . , pk of the lookup key, i.e. the auxiliary data 108 comprises the bit values a(p1), . . . , a(pk). Furthermore, the auxiliary data 108 may comprise padding bits in order to keep the size of the auxiliary data constant even if the number of the bit values a(p1), . . . , a(pk) were different in conjunction with different lookup keys. The subsystem 102 is configured to form the auxiliary data 108 on the basis of the indicator data 107 and the lookup key 105. In FIG. 1a, the forming the auxiliary data is depicted with a functional block 104. It is also possible that the above-mentioned indicator data is a mask that is a vector of bits having a first bit value, typically zero ‘0’, on bit positions corresponding to the do-not-care bit positions of the lookup key and a second bit value, typically one ‘1’, on bit positions corresponding to the significant bit positions, i.e. other than the do-not-care bit positions, of the lookup key. In such cases where the do-not-care bit positions are located consecutively at a pre-determined portion of the lookup key 107, the indicator data can be a mere numerical value which directly or indirectly indicates the number of the do-not-care bit positions of the lookup key. In Internet protocol “IP” address lookups, the do-not-care bit positions are typically located at the end of the lookup key. The forming the auxiliary data 108, i.e. the functional block 104, can be implemented for example with a gate logic array or with a programmable processor.

In the exemplifying lookup system illustrated in FIG. 1a, the subsystem 102 comprises a device 103 configured to receive the auxiliary data 108 as input data and to produce output data 109 which, together with the preliminary lookup result 106, constitutes the final lookup result 110 as illustrated in FIG. 1a. The output data 109 is a vector of bit values c(1), . . . c(q), where q is the word-length of the output data 109. The device 103 can be for example a random-access memory “RAM” or a gate logic array, or the device 103 can be implemented with a programmable processor.

FIG. 1b shows a schematic illustration of a lookup system according to another exemplifying and non-limiting embodiment of the invention. The lookup system comprises a ternary content-addressable memory “TCAM” 111 configured to carry out a lookup on the basis of a lookup key 115 so as to produce a preliminary lookup result 116. The lookup system comprises a subsystem 112 configured to produce a final lookup result 120 on the basis of the preliminary lookup result 116 and auxiliary data 118 that comprises all or pre-determined ones of the bit values of do-not-care bit positions of the lookup key 115. The lookup result 120 is a vector of bit values r(1), . . . r(p), where p is the word-length of the lookup result.

In the exemplifying lookup system illustrated in FIG. 1b, the TCAM 101 is configured to produce indicator data 117 in addition to the preliminary lookup result 116 when carrying out the lookup on the basis of the lookup key 115. The indicator data indicates the do-not-care bit positions of the lookup key 115. In this exemplifying case, it is assumed that the do-not-care bit positions of the lookup key 115 are at the end of the lookup key. The indicator data 117 comprises a numerical value M which expresses the number of significant bit positions at the beginning of the lookup key 115, where the significant bit positions are the bit positions other than the do-not-care bit positions. In IP-address lookups, the above-mentioned indicator data 117 represents the mask length. The subsystem 112 is configured to extract the bit values of the do-not-care bit positions of the lookup key, i.e. the bit values a(M+1), . . . , a(n), on the basis of the indicator data 117 so as to form the auxiliary data 118. The auxiliary data 118 may comprise padding bits in order to keep the size of the auxiliary data constant even if the number of the bit values a(M+1), . . . , a(n) were different in conjunction with different lookup keys. In FIG. 1b, the forming the auxiliary data 118 is depicted with a functional block 114.

In the exemplifying lookup system illustrated in FIG. 1b, the subsystem 112 comprises a device 113 configured to receive a combination of the auxiliary data 118 and the preliminary lookup result 116 as input data and to produce the final lookup result 120. The device 113 can be for example a random-access memory “RAM” or a gate logic array, or the device 113 can be implemented with a programmable processor.

In cases where the do-not-care bit positions are located in a pre-determined and á priori known manner in the lookup key, the functional blocks 104 and 114 for forming the auxiliary data are not necessary. In these cases, all or pre-determined ones of the bit values of the á priori known do-not-care bit positions of the lookup key can be connected directly from the lookup key to an input of the device 103 or 113, wherein these directly connected bit values represent the above-mentioned auxiliary data 108 or 118.

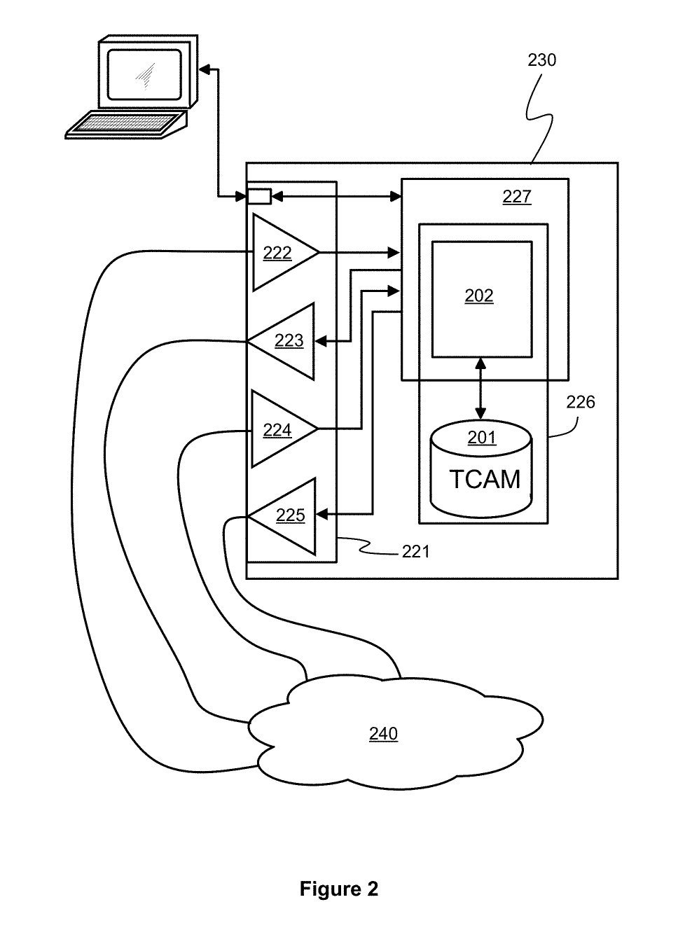

FIG. 2 shows a schematic illustration of a network element 230 according to an exemplifying and non-limiting embodiment of the invention. The network element can be, for example, an Internet Protocol “IP” router, a Multiprotocol label switching “MPLS” switch, a packet optical switch, an Ethernet switch, an asynchronous transfer mode “ATM” switch, a software-defined networking “SDN” controlled network element, and/or a virtualized network function runnable in a virtual machine. The network element 230 comprises a data transfer interface 221 for receiving data and for transmitting data. The data transfer interface 221 comprises ingress ports 222 and 224 and egress ports 223 and 225 for connecting via data transfer links to other elements of a data transfer network. In FIG. 2, the elements of the data transfer network other than the network element 230 are depicted with a cloud 240.

The network element comprises a processing system 227 for controlling data-forwarding and other functionalities of the network element. The network element comprises a lookup system 226 for carrying out lookups so that a lookup key relates to data being managed by the network element 230 and a lookup result produced by the lookup system 226 at least partly determines operations to be carried out by the network element. The lookup system 226 comprises a ternary content-addressable memory 201 “TCAM” configured to carry out a lookup on the basis of a lookup key so as to produce a preliminary lookup result. The lookup system 226 further comprises a subsystem 202 configured to produce a final lookup result on the basis of the preliminary lookup result and auxiliary data comprising at least a part of bit values of do-not-care bit positions of the lookup key. In this exemplifying case, the above-mentioned subsystem 202 is implemented with the aid of the processing system 227. Various different implementations are however possible. The lookup system 226 can be, for example, according to any of the exemplifying and non-limiting embodiments of the invention described above with reference to FIGS. 1a and 1b.

The processing system 227 of the network element can be implemented with one or more processor circuits, each of which can be a programmable processor circuit provided with appropriate software, a dedicated hardware processor such as, for example, an application specific integrated circuit “ASIC”, or a configurable hardware processor such as, for example, a field programmable gate array “FPGA”. Furthermore, the processing system 227 may comprise one or more memory circuits such as random-access memory “RAM” circuits.

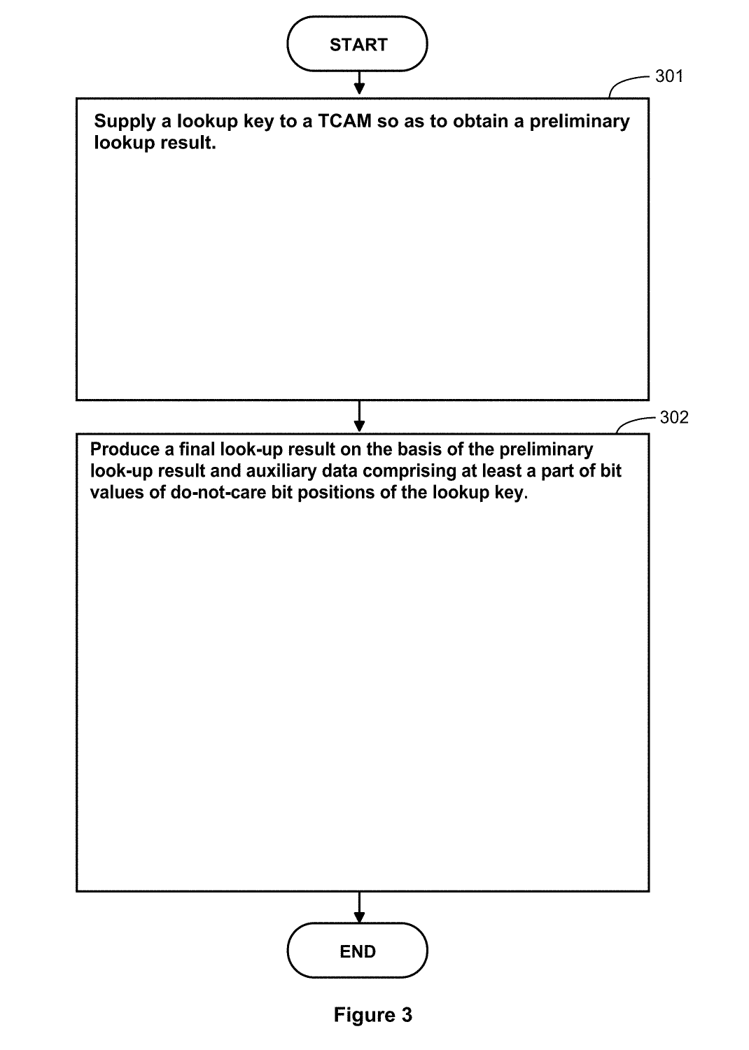

FIG. 3 shows a flowchart of a lookup method according to an exemplifying and non-limiting embodiment of the invention. The lookup method comprises the following actions:
action 301: supplying a lookup key to a ternary content-addressable memory “TCAM” so as to obtain a preliminary lookup result, and
action 302: producing a lookup result on the basis of the preliminary lookup result and auxiliary data comprising at least a part of bit values of do-not-care bit positions of the lookup key such that the preliminary lookup result is independent of the bit values of the do-not-care bit positions.

In a lookup method according to an exemplifying and non-limiting embodiment of the invention, the ternary content-addressable memory produces indicator data in addition to the preliminary lookup result when carrying out the lookup on the basis of the lookup key. The indicator data indicates the do-not-care bit positions of the lookup key, and the lookup method according to this exemplifying and non-limiting embodiment of the invention comprises forming the auxiliary data on the basis of the indicator data and the lookup key. The indicator data may comprise for example pointers to the do-not-care bit positions of the lookup key. For a second example, the indicator data may comprise a mask that is a bit vector having a first bit value, e.g. ‘0’, on bit positions corresponding to the do-not-care bit positions of the lookup key and a second bit value, e.g. ‘1’, on bit positions corresponding to other, i.e. significant, bit positions of the lookup key. In cases where the do-not-care bit positions are located consecutively at a pre-determined portion of the lookup key e.g. at the end of the lookup key, the indicator data can be a mere numerical value which directly or indirectly indicates the number of the do-not-care bit positions.

A lookup method according to an exemplifying and non-limiting embodiment of the invention comprises supplying the auxiliary data to a device which produces output data constituting, together with the preliminary lookup result, the lookup result. A lookup method according to another exemplifying and non-limiting embodiment of the invention comprises supplying a combination of the auxiliary data and the preliminary lookup result to a device which produces the lookup result. The abovementioned device can be e.g. a random-access memory “RAM” or a gate logic array, or the device can be implemented with a programmable processor.

A computer program according to an exemplifying and non-limiting embodiment of the invention comprises computer executable instructions for controlling a programmable processing system to carry out actions related to a method according to any of the above-described exemplifying and non-limiting embodiments of the invention.

A computer program according to an exemplifying and non-limiting embodiment of the invention comprises software modules for carrying out lookups. The software modules comprise computer executable instructions for controlling a programmable processing system to:
supply a lookup key to a ternary content-addressable memory so as to obtain a preliminary lookup result, and
produce a lookup result on the basis of the preliminary lookup result and auxiliary data comprising at least a part of bit values of do-not-care bit positions of the lookup key such that the preliminary lookup result is independent of the bit values of the do-not-care bit positions.

The software modules can be e.g. subroutines or functions implemented with a suitable programming language and with a compiler suitable for the programming language and the programmable processing system under consideration. It is worth noting that also a source code corresponding to a suitable programming language represents the computer executable software modules because the source code contains the information needed for controlling the programmable processing system to carry out the above-presented actions and compiling changes only the format of the information. Furthermore, it is also possible that the programmable processing system is provided with an interpreter so that a source code implemented with a suitable programming language does not need to be compiled prior to running.

A computer program product according to an exemplifying and non-limiting embodiment of the invention comprises a computer readable medium, e.g. a compact disc “CD”, encoded with a computer program according to an exemplifying embodiment of invention.

A signal according to an exemplifying and non-limiting embodiment of the invention is encoded to carry information defining a computer program according to an exemplifying embodiment of invention.

The specific examples provided in the description given above should not be construed as limiting the scope and/or the applicability of the appended claims.

1-16. (canceled)

17. A lookup system comprising:
a ternary content-addressable memory configured to carry out a lookup on the basis of a lookup key so as to produce a preliminary lookup result, the lookup key comprising do-not-care bit positions so that the preliminary lookup result is independent of bit values of the do-not-care bit positions, and
a subsystem configured to produce a lookup result on the basis of the preliminary lookup result and auxiliary data comprising at least a part of the bit values of the do-not-care bit positions of the lookup key.

18. A lookup system according to claim 17, wherein the ternary content-addressable memory is configured to produce, in addition to the preliminary lookup result when carrying out the lookup on the basis of the lookup key, indicator data indicative of the do-not-care bit positions of the lookup key, and the subsystem is configured form the auxiliary data on the basis of the indicator data and the lookup key.

19. A lookup system according to claim 18, wherein the indicator data is a mask that is a bit vector having a first bit value on bit positions corresponding to the do-not-care bit positions of the lookup key and a second bit value, different from the first bit value, on bit positions corresponding to other bit positions of the lookup key.

20. A lookup system according to claim 18, wherein the indicator data is a numerical value indicating number of the do-not-care bit positions of the lookup key, the do-not-care bit positions locating consecutively at a pre-determined portion of the lookup key.

21. A lookup system according to claim 17, wherein the subsystem comprises a device configured to receive the auxiliary data as input data and to produce output data which, together with the preliminary lookup result, constitutes the lookup result.

22. A lookup system according to claim 17, wherein the subsystem comprises a device configured to receive a combination of the auxiliary data and the preliminary lookup result as input data and to produce the lookup result.

23. A network element comprising:
a data transfer interface for connecting the network element to a data transfer network, and
a lookup system for carrying out a lookup so that a lookup key of the lookup relates to data being managed by the network element and a lookup result produced by the lookup system determines at least partly operations to be carried out by the network element,
wherein the lookup system comprises:
a ternary content-addressable memory configured to carry out the lookup on the basis of the lookup key so as to produce a preliminary lookup result, the lookup key comprising do-not-care bit positions so that the preliminary lookup result is independent of bit values of the do-not-care bit positions, and
a subsystem configured to produce the lookup result on the basis of the preliminary lookup result and auxiliary data comprising at least a part of the bit values of the do-not-care bit positions of the lookup key.

24. A network element according to claim 23, wherein the network element is at least one of the following: an Internet Protocol “IP” router, a MultiProtocol Label Switching “MPLS” switch, a packet optical switch, an Ethernet switch, an asynchronous transfer mode “ATM” switch, a software-defined networking “SDN” controlled network element, a virtualized network function runnable in a virtual machine.

25. A lookup method comprising:
supplying a lookup key to a ternary content-addressable memory so as to obtain a preliminary lookup result, the lookup key comprising do-not-care bit positions so that the preliminary lookup result is independent of bit values of the do-not-care bit positions, and
producing (302) a lookup result on the basis of the preliminary lookup result and auxiliary data comprising at least a part of the bit values of the do-not-care bit positions of the lookup key.

26. A lookup method according to claim 25, wherein the ternary content-addressable memory produces, in addition to the preliminary lookup result when carrying out a lookup on the basis of the lookup key, indicator data indicative of the do-not-care bit positions of the lookup key, and the lookup method comprises forming the auxiliary data on the basis of the indicator data and the lookup key.

27. A lookup method according to claim 26, wherein the indicator data is a mask that is a bit vector having a first bit value on bit positions corresponding to the do-not-care bit positions of the lookup key and a second bit value, different from the first bit value, on bit positions corresponding to other bit positions of the lookup key.

28. A lookup method according to claim 26, wherein the indicator data is a numerical value indicating number of the do-not-care bit positions of the lookup key, the do-not-care bit positions locating consecutively at a pre-determined portion of the lookup key.

29. A lookup method according to claim 25, wherein the lookup method comprises supplying the auxiliary data to a device which produces output data constituting, together with the preliminary lookup result, the lookup result.

30. A lookup method according to claim 25, wherein the lookup method comprises supplying a combination of the auxiliary data and the preliminary lookup result to a device which produces the lookup result.

31. A non-transitory computer readable medium encoded with a computer program comprising computer executable instructions for controlling a programmable processing system to:
supply a lookup key to a ternary content-addressable memory so as to obtain a preliminary lookup result, the lookup key comprising do-not-care bit positions so that the preliminary lookup result is independent of bit values of the do-not-care bit positions, and
produce a lookup result on the basis of the preliminary lookup result and auxiliary data comprising at least a part of the bit values of the do-not-care bit positions of the lookup key.
